(19) United States
(12) Patent Application Publication
(10) Pub. No.: US 2021/0374164 A1
(43) Pub. Date: Dec. 2, 2021

(54) AUTOMATED AND DYNAMIC METHOD AND SYSTEM FOR CLUSTERING DATA RECORDS

(71) Applicant: Banque Nationale du Canada, Montreal (CA)

(72) Inventors: Nizar Ghoula, Montreal (CA); Reyhaneh Rezvani, Montreal (CA); Bolin Li, Montreal (CA); Francis Benoit, Montreal (CA)

(21) Appl. No.: 17/336,770

(22) Filed: Jun. 2, 2021

Related U.S. Application Data
(60) Provisional application No. 63/033,425, filed on Jun. 2, 2020.

(51) Int. Cl. G06F 16/28; G06F 16/23; G06K 9/62; G06N 20/00

(52) U.S. Cl. CPC G06F 16/285; G06F 16/2308; G06N 20/00; G06K 9/6215; G06K 9/6256

(57) ABSTRACT

An automated and dynamic method for clustering records of data is provided, as well as a system and a non-transitory storage medium for performing the method. The method comprises generating comparison vectors associated with pairs of records. Each vector associated with a pair comprises a set of values, each value being associated with one of the predefined features and representing a comparison result of the values of the predefined feature for the first and second records of the pair. The method comprises inputting the comparison vectors into a trained non-linear similarity model and generating therefrom similarity scores. The method also comprises inputting the similarity scores into a clustering algorithm and creating clusters of records therefrom. Clusters created can be sent to a graphical user interface or to a processing device for further treatment.

### RELATED APPLICATIONS

This application claims the benefit of the Jun. 2, 2020 priority date of U.S. Application Ser. No. 63/033,425, the contents of which are incorporated by reference.

### TECHNICAL FIELD

The technical field generally relates to machine learning, and more particularly relates to improved systems and methods for the automated clustering of data records using machine learning models.

### BACKGROUND

The grouping of similar data is useful in a number of different applications. For instance, grouping similar data may help for their reconciliation.

Reconciliation is a process that requires matching data that are related. The reconciliation of transactions is a colossal task when there are thousands of transactions in a single account on a daily basis. While there exist many accounting solutions that automate, at least in part, the reconciliation of transactions, there are always a number of transactions that remain unreconciled at the end of the process, referred to as “exceptions”, and that need to be further investigated by clerks.

There is a need for systems and methods that can help improve or facilitate the process of grouping data records, such as for a reconciliation process.

### SUMMARY

According to an aspect, an automated computer-implemented method is provided, for grouping data records for improving the efficiency of a clustering process. The method comprises accessing, from one or more storage systems, an initial dataset of data records, each data record being structured with predetermined fields; generating, by a processor, comparison vectors associated with pairs of data records from the initial dataset, each vector associated with a pair comprising a set of values, each value being associated with one of the predetermined fields and representing a comparison result of the values in said field for the first and second data records of a pair; inputting the comparison vectors into a trained non-linear similarity model, stored onto a storage medium, and generating therefrom similarity scores, each similarity score providing an indication of the degree of similarity between the two data records in the pair; inputting, by the processor, the similarity scores into a clustering algorithm, and creating therefrom clusters of data records; and removing, by the processor, from the dataset, the data records in the created clusters that have been determined as reconciled.

According to another aspect, an automated and dynamic system for clustering data records pertaining to different datasets is provided. The system comprises:
one or more storage systems for storing an initial dataset of data records, each data record being structured with predetermined fields;
a pair generator and a comparison algorithm toolbox for generating comparison vectors associated with pairs of data records from the initial dataset, each vector associated with a pair comprising a set of values, each value being associated with one field and representing a comparison result of the values in said field for the first and second data records of a pair;
at least one trained non-linear similarity model receiving as an input the comparison vectors, and generating therefrom a matrix of similarity scores, each similarity score providing an indication of the degree of similarity between the two data records in the pair of the group;
a clustering algorithm for receiving as an input the matrix of similarity scores, and creating therefrom clusters of transaction records; and
a graphical user interface for receiving as input reconciled data records in a given one of the clusters and for removing reconciled data records from the initial dataset.

According to another aspect, a non-transitory storage medium is provided. The non-transitory computer readable medium stores processor-executable instructions for causing a processor to:
a) generate comparison vectors associated with pairs of data records from an initial dataset of data records, each data record being structured with predetermined fields, each vector associated with a pair comprising a set of values, each value being associated with one of the predetermined fields and representing a comparison result of the values in said field for the first and second data records of a pair;
b) input the comparison vectors into a trained non-linear similarity model and generate therefrom similarity scores, each similarity score providing an indication of the degree of similarity between the two data records in the pair;
c) input the similarity scores into a clustering algorithm, and create therefrom clusters of data records;
d) remove from the dataset the data records in the created clusters that have been determined as reconciled.

### BRIEF DESCRIPTION OF THE FIGURES

Other features and advantages of the present invention will be better understood upon reading the following non-restrictive description of possible implementations thereof, given for the purpose of exemplification only, with reference to the accompanying drawings in which:

FIG. 1 is a schematic diagram showing different sources of data records, which are fed to a reconciliation application, according to a possible embodiment. FIG. 1 also schematically illustrates a table or data structure containing a plurality of unreconciled data records.

FIG. 2 is schematic diagram showing a classifier model used to estimate values of unpopulated or missing fields of the data records, according to a possible embodiment.

FIG. 3 is a schematic diagram showing the grouping data records, based on the values contained in at least some of the fields of the training data records, according to a possible embodiment.

FIG. 4 is a schematic diagram showing the data records being fed to a pair generator, to create pairs of data records, according to a possible embodiment.

FIG. 5 is a schematic diagram showing the generation of comparison vectors respectively associated with pairs of data records. Comparison vectors being fed to trained non-linear similarity models which in turn generate similarity scores.

FIG. 6 is a schematic diagram showing the similarity scores being inputted to clustering algorithms, according to a possible embodiment.

FIG. 7 is a schematic diagram showing experimental results obtained from inputting similarity function to a clustering algorithm, according to a possible embodiment.

FIG. 8 is a flow chart of steps of the method for grouping data records as part of a reconciliation process, according to a possible embodiment.

### DETAILED DESCRIPTION

In the following description, similar features in the drawings have been given similar reference numerals and, to not unduly encumber the figures, some elements may not be indicated on some figures if they were already identified in a preceding figure. It should be understood herein that the elements of the drawings are not necessarily depicted to scale, since emphasis is placed upon clearly illustrating the elements and interactions between elements.

The term “processing device” encompasses computers, nodes, servers, NIC (network interface controllers), switches and/or specialized electronic devices configured and adapted to receive, store, process and/or transmit data. “Processing devices” include processing means, such as microcontrollers and/or microprocessors, CPUs, or are implemented on FPGAs, as examples only. The processing means are used in combination with storage medium, also referred to as “memory” or “storage means”. Storage medium can store instructions, algorithms, rules and/or transaction data to be processed. Storage medium encompasses volatile or non-volatile/persistent memory, such as registers, cache, RAM, flash memory, ROM, as examples only. The type of memory is, of course, chosen according to the desired use, whether it should retain instructions, or temporarily store, retain or update data.

By “model”, we refer to machine learning models. The models can comprise one or several algorithms that can be trained, using training data. New data can thereafter be inputted to the model which predicts or estimates an output according to parameters of the model, which were automatically learned based on patterns found in the training data.

In the present description, the term “data record” refers to a collection of data values, such as a data structure, which can be stored in memory and which holds, contains or provides access to a group of values relating to a given transaction. A transaction is defined by different fields, such as amount, date, account number, type, currency, as examples only. The values of the different fields defining a data record can be stored permanently or temporarily, and can be transmitted or saved in database tables, arrays, files (such as ASCII, ASC, .TXT, .CSV, .XLS, etc.) and can be stored on, or transit in memory, such as registers, cache, ROM, RAM or flash memory, as examples only. The different fields can include numeral, date or character values. In the context of a reconciliation process, a “data record” may also be referred to as transaction data or transaction record.

The reconciliation of data records is a process that requires the matching of data of different types, such as transaction records stored and/or accessible from different sources, to verify that they are in agreement. As an example, data records from a financial statement can be compared to accounting records of a given account, and if a correspondence can be found for each record or group of records, the transactions are said to be “reconciled.” Data records are thus reconciled when a given condition on the values contained in one or more fields of the records are met, such as the sum of the values “amount” field is less than 1, and/or if the dates in the “date” field are within 2 days, etc. When transaction records from two or more accounts are reconciled, the accounts are said to “balance.” Simply put, the reconciliation process is used to ensure that a given asset, such as money, leaving an account matches the asset spent or consumed.

While the reconciliation process is a process performed in all types and sizes of entities and organizations, from individuals to large corporations and financial institutions, the reconciliation process of transaction records can be extremely complex and time consuming when large volumes of transactions are involved, from large numbers of accounts and system sources. Some regulations or business rules require that the reconciliation process be completed within a predetermined period, such as daily, and thus the computing systems and applications that perform automated reconciliations are required to be fast, efficient and accurate. As an example, only, automated reconciliations systems may need to process over 7,000 transactions daily, for a single account, and an organization may manage thousands of accounts. Transaction records can be matched one on one, but not necessarily. For example, a transaction record in a financial statement can describe the payment of a balance on a credit card account, and that transaction record can be matched or reconciled with a number of different transaction records corresponding to the purchase of different products or services, in one currency or another. To determine whether a set of transactions are reconciled, the value of a monetary field can be used. In the example of the credit card statement, the amount of the payment to the credit card account was negative $100, and the transaction amounts of items purchased using the credit card were recorded as $25, $25 and $50. The four transactions (payment to credit card account, and payment of three items) are reconciled since the sum of the transactions is equal to 0$.

While existing reconciliation systems can automate most of the transaction process, there remain transaction records that cannot be reconciled automatically, referred to as “exception” transactions. For example, the sum of the transactions can differ from 0$, there can be errors or inconsistencies in the date or time of the transactions, in the account numbers and/or sender/receiver identification. Such transactions typically need to be reconciled manually, which is ineffective and time-consuming. In order to increase the reconciliation rate of transactions, existing reconciliation applications provide that ability to relax the reconciliation rules according to which transaction records are considered as matched. While in some cases, this relaxing of the rules effectively increases the number of transaction records matched, some transactions that shouldn't have been matched are considered reconciled, generating inconsistencies, which may lead to financial losses.

There is therefore a need for a new dynamic clustering method and corresponding system to help improve an array of processes where similar data records comprising multiple fields with different types of values must be grouped accurately, such as in the reconciliation process. More precisely, the new dynamic clustering method and system should also be suited for grouping data records coming from large datasets generated by different sources, including when newly generated data records must be processed along with previously processed data records.

The main challenge in developing this new method is the ability to obtain meaningful clusters of data records comprising multiple fields composed of different types of values, such as transaction records having entity values (transit codes, sender, receiver, etc.), categorical values (type of data), numeric values (amount) or date values (processing date, reception date, account date). With this type of data records, the use of classical distance-based clustering methods, such as Euclidean distance clustering, may necessitate the transformation of entity or categorical values into numeric values with one-hot encoding methods, for example, and is limited by a linear assessment of similarity between data records.

Thus, classical distance-based clustering methods lead to increased processing time due, in part, to the increased number of fields (dimensions) resulting from one-hot encoding. These clustering methods also lead to approximate clustering of data records deemed similar since the similarity between data records may not be captured adequately by a linear function where the predictive value of each field in a data record is not fully taken into account for assessing complex similarity patterns between data records. The new dynamic clustering method and system disclosed herein overcomes these issues and is particularly well suited for clustering data records, such as transaction records. A person of skill in the art would nonetheless understand that the method could be applied to other types of data records. Also, the new dynamic clustering method disclosed herein allows to tailor similarity functions (or models) for subsets of data records identified in a large dataset in order to obtain accurate similarity functions for each subset by eliminating the noise resulting from irrelevant similarity comparisons, thereby improving both processing time and clustering relevance.

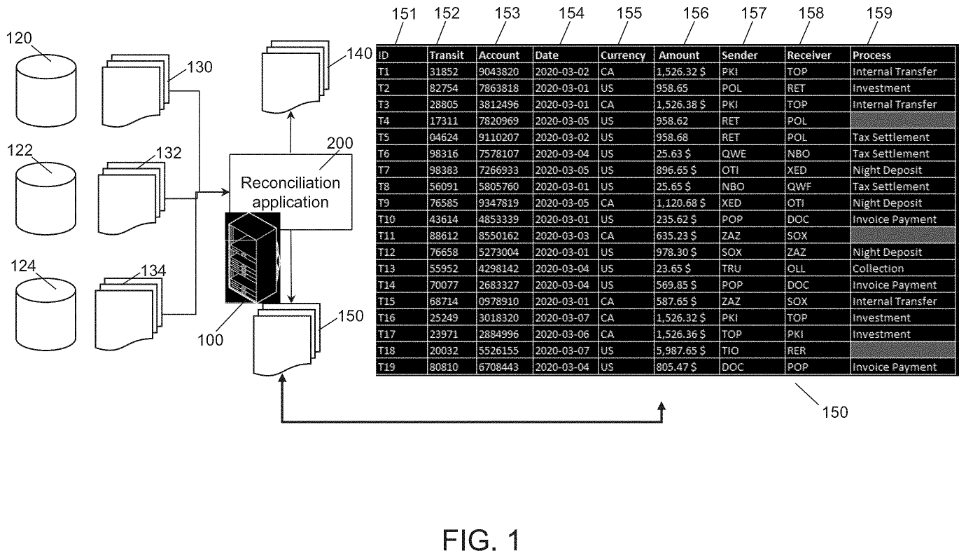

Referring to FIG. 1, different systems that can generate data records are schematically represented with numerals 120, 122 and 124. The systems can include one or more databases, servers or repository systems, with tables, lists or queues 130, 132, 134 of data records that need to be reconciliated. The data records are fed to a reconciliation system or application 200. The reconciliation application 200 processes the data records by applying different sets of reconciliation rules, which generate sets of reconciled data records 140, and sets of unreconciled data records 150. In order to increase the reconciliation rate of the data records, in some possible implementation, classification fields can be added to the data records, in addition to more standard record fields. The data records, such as transaction records identified by T1 to T19 in FIG.1, are structured with predetermined fields. In the example, the data record fields include a transaction identification (ID) 151, a transit number 152, an account number 153, a date of the transaction 154, the amount and currency 156,155, a transmitter or sender identification 157 and a receiver identification 158. A transaction record can include additional fields, indicative of the type or characteristics of the transactions, which can be used for classification purposes, as discussed in more details below. In the example of FIG. 1. the field “process” 159 corresponds to such a field. It will be appreciated that table 150 in FIG. 1 is provided as an example only, and that the number and types of “classification” fields of data records can differ from one application to the other. In addition, the example provided has been simplified, to better explain the automated process proposed. While in the exemplary embodiment of FIG. 1 a single table is shown, in application, the unreconciled data records 150 can be spread over several tables and files, and the tables or files can include a different number of columns or “fields”. The “classification” fields, such as process field 159, can differ from one application to another (for example, banking applications compared to retail applications), and thus can be customized to reflect characteristics of data records of a given application.

In order to increase the efficiency, accuracy and speed of the reconciliation process, especially for exception data records that existing reconciliation systems have been unable to reconcile, an automated computer-implemented method is provided, for grouping transactions records. As part of the process, one or more trained non-linear similarity model(s) are used to estimate or predict a similarity between data records. More specifically, similarity scores are generated for pairs of records (such as transaction records), where each similarity score provides an indication of the degree of similarity between two data records. The method then involves inputting the similarity scores to one or more clustering algorithms, which generate clusters of data records (such as transaction records) that are similar and likely to be reconciled. The groupings of records performed according to the proposed method allows increasing the reconciliation rate compared to existing conventional methods, while reducing the time required for reconciling the transaction records. In preferred embodiments, the automated method can be iterative, by being periodically repeated, so a batch of new unreconciled data records can be added to unreconciled data records of past periods, forming new clusters of data records. In another embodiment, the automated method can be continuous, by being constantly repeated, so new unreconciled data records can be continuously added or streamed to unreconciled data records forming new clusters of records.

The one or more non-linear similarity model(s) must first be trained with training dataset(s) of training data records, as will be explained in more detail with reference to FIGS. 1 to 5. The training transaction records are structured with the same predetermined fields as those of the transaction records that need to be reconciled. In the example of FIG. 1, the dataset of training transactions would be structured with the fields 151 to 159. In some cases, for both the training data records and the data records to be reconciled, values in some of the fields may be missing. Table 150 in FIG. 1 comprises three data records, T4, T11 and T18 having missing values for the classification “process” field.

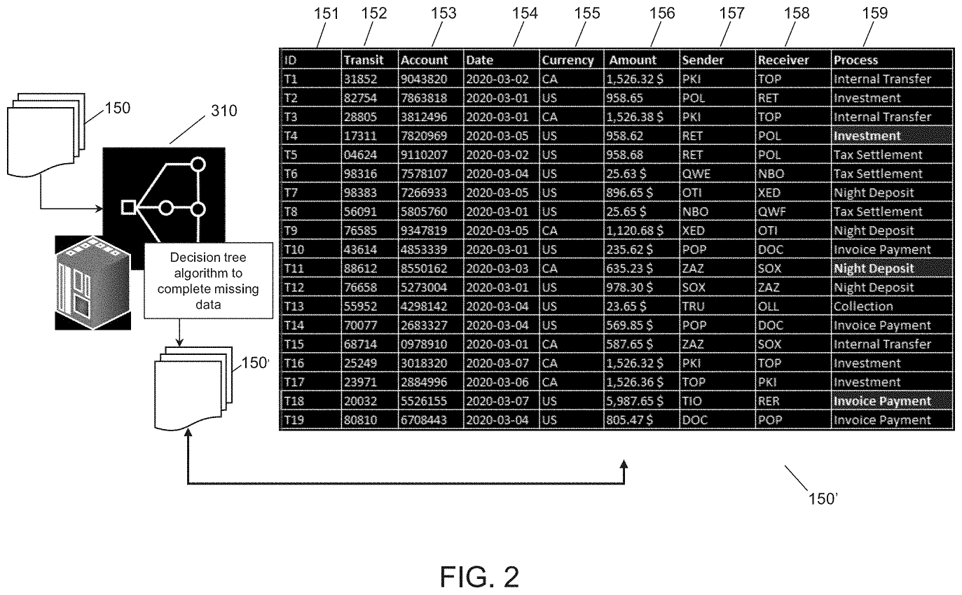

Referring to FIG. 2, for both the training and unreconciled data records, the method can include a step of estimating values of unpopulated or missing fields. In the example of FIG. 2, the missing “process” fields are estimated using one or more classifier model 310, trained on past transaction records which fields are all populated. In the example, the missing values are all relating to the “process” classification field, but the missing values can be for any of the fields 151-159, although it is more common to have missing values in “classification” fields. Also, as mentioned previously, the data records could include additional classification fields, such as an “activity” which relates to a step of a process to which a transaction record is associated with, or a “type” field, which relates to the type of currency of a transaction record. For example, a reconciliation process for a financial institution may consist in the clearing of different types of transactions made between clients and may comprise many steps, or activities, like controlling the clearing of checks received in branches. Another activity for the clearing process may be the assessment that transaction amounts treated by the financial institution are debited from the account of a payor. Both activities may be conducted exclusively with transactions involving Canadian currencies. Therefore, the “type” of both activities would be CAD, and the “type” field for each transaction related to this activity would also be “CAD”. In another example, a reconciliation process for a financial institution may consist in the treatment of transactions made by clients in favour of the financial institution, for which an activity may be controlling that mortgage payments are made through a specific system. There can be one classifier model 310 associated with each field (process, type and/or activity), and the raw transaction records generated directly by a source will typically not include the classification fields. The classification fields and associated values can be added to the raw data records in order to improve the efficiency and rapidity in forming clusters of transaction records, as will be explained in more detail below. In FIG. 2, the classifier model 310 is a decision tree model, but other types of models and methods can be used, such as clustering-based methods, replacement of the missing values by the median value of all values of the field, neural networks, SVM or gradient boosting.

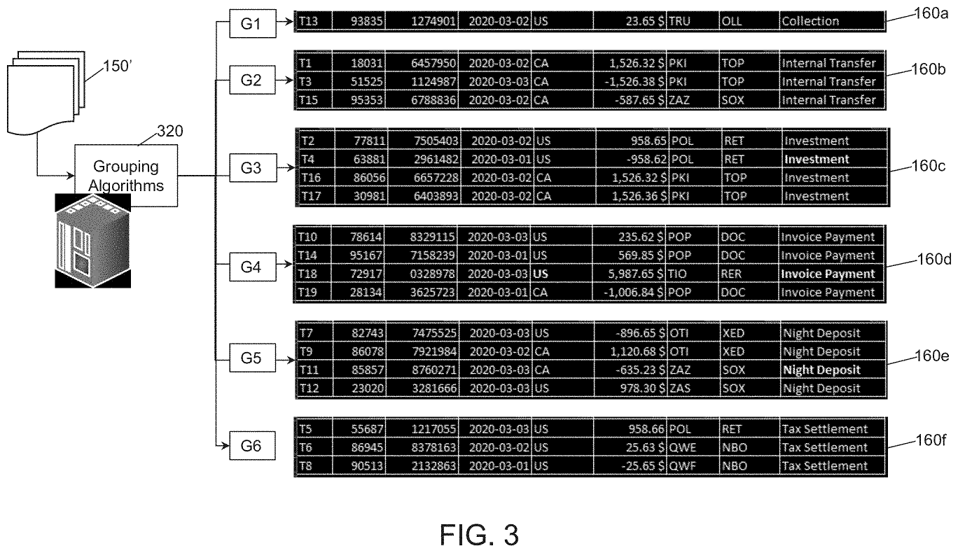

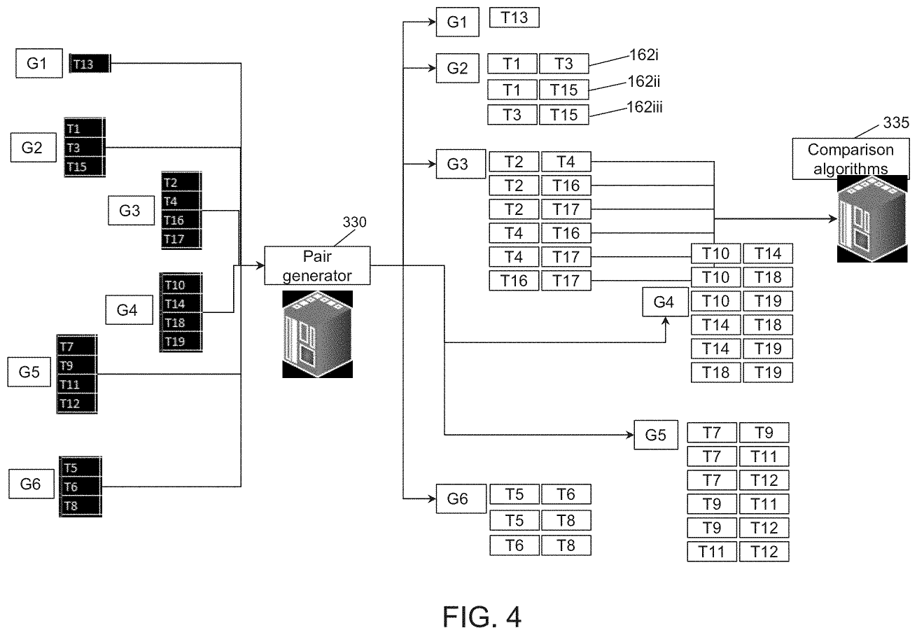

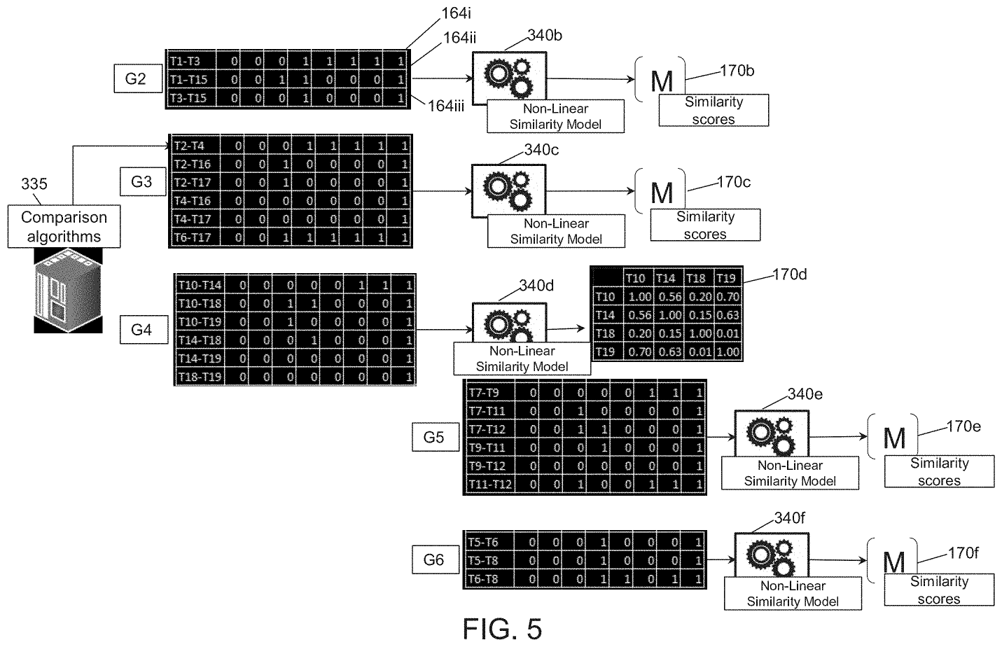

Once all fields are filled with values, the process comprises an optional step of determining groups of training data records. Referring to FIG. 3, the groups 160a-160f are based on the values contained in at least some of the fields of the training data records, such as based on the “classification” fields, so as to classify the data records of the training dataset into the groups and train a non-linear similarity model for each group. This step of the method is aimed at improving the fitness of the trained non-linear similarity model for each group by reducing the number of data records already known as dissimilar in the training dataset of a group, thereby reducing noise. In the example of FIG. 3, six groups G1-G6 are created, according to the values found in the “process” field, using grouping algorithms 320. In the exemplary embodiment, the groupings are made based on a set of rules (such as whether the field “process” is the same, for example). In other embodiments, different types of models and methods can be used for creating groups such as clustering-based methods, decision tree models, neural networks, SVM or gradient boosting. In alternate embodiments, where additional classification fields are used, the groups can be based on more than one field, such as based on “type”, “process” and “activity” fields, as in the example provided previously. The grouping step can also be useful to reduce the number of pairwise comparisons that need to be conducted, thus reducing the processing time related to the generation of similarity scores of all pairs of a transaction record dataset. As an example only, during trials of the proposed method, where transaction records relating to banking operations have been used, and for which the reconciliation process is to be performed daily, training transaction records were divided into about fifty groups, each group comprising between 300 and 1200 transactions. The grouping allowed parallelizing the process of generating pairs of transactions and generating comparison vectors and reduced the time and processing capacity required to train a similarity model for each group, as will be explained with reference to FIGS. 4 and 5.

The grouping of data records is however optional, since, depending on the application and number of transaction records to be processed, it may be possible to determine similarity scores for pairs of transaction records in a reasonable period of time, without having to first divide the transactions into groups, provided the number of transaction records is limited and/or the processing capacity of the servers is sufficient.

Referring now to FIG. 4, according to the exemplary embodiment, the data records of each group are fed to a pair generator or pair generation module 330. The pair generator 330 can be implemented as an algorithm that may generate all possible combinations of pairs of transaction records. For implementations where the data records are first divided in groups, the pair generator 330 creates all possible pairs of transactions within a given group. In the example presented, the initial dataset of data records only contains 19 transaction records, but it will be appreciated in practical implementations, transaction datasets can typically include thousands of records, and the number of possible pairwise combinations rapidly increases with the number of records to be processed, as more precisely described by n*(n−1)/2, where n is the number of data records. For example, 44,850 unique pairs can be formed with a set of 300 data records. The initial grouping of transactions is thus especially useful for large datasets of data records.

Referring to FIGS. 4 and 5, according to a possible implementation, for each pair of data records, a comparison vector is generated or created, using a toolbox of comparison algorithms 335. A distinct comparison algorithm or function can be used for comparing the values of each different field and/or the same comparison algorithm can be used for multiple fields. For example, a “true or false” comparison algorithm can be used for all fields relating to categories or entity values. In the example, a “true or false” comparison algorithm can be used to compare the values in the “currency” field of a pair of transactions. A “difference comparison” algorithm can be used for “date and time” fields, and for “amount” fields, and a “distance comparison” algorithm can be used to compare the “sender” and the “identifier” fields. As can be appreciated, different types of comparison algorithm can be used, depending on the information contained in the fields of the data records. Thus, for each pair of records of a group, a comparison vector, such as vector 164i, 164ii, 164iii (identified in FIG. 5) is generated and stored in memory. In order to be able to feed the comparison vectors to the non-linear similarity models 340, the values of the comparison vector are preferably standardized. For example, for the currency field, a “true” result can be converted to “1” if the currency of each data record is the same, and a “false” result can be converted to “0” if the currency is different. According to the same reasoning, if the “sender” identifications are substantially similar for both values, the result of the comparison algorithm for this field can be set to 1, and to 0 if not. The comparison results of each vector can thus be set to be fixed values, such as 0 or 1, or can range between boundary values, such as between or equal to 0 and 1. Different types of standardization processes can be applied to the result values of the comparison vectors, depending on the specific applications in which the proposed method is used.

In order to train the similarity functions 340b to 340f, the comparison vectors used for training (referred to as “training comparison vectors”) have preferably been attributed to classes or categories. The attribution of a class or a category can also be referred to as “labelling” in the jargon of Machine Learning. The labels for the training vectors can correspond to “similar” or “reconciled” labels and to “dissimilar” or “unreconciled” labels. Preferably, the training method used for training the similarity functions is a supervised training, where pairs of data records have been previously labelled as similar or dissimilar based on the knowledge of reconciliation experts. In alternate implementations of the proposed method, the training of the similarity functions can be semi-supervised or unsupervised. That is, the training dataset may have little to no pre-exiting labels.

Still referring to FIG. 5, the labelled comparison vectors are fed, for each group, to a distinct model or algorithm 340b-340f for training the different similarity functions or models 340b-340f. As mentioned above, the training of a non-linear similarity model has the advantage of capturing more patterns when comparing two data records that cannot be captured by a simple linear function commonly used in classical distance-based clustering methods. A trained non-linear similarity model takes into account, or weights, the relative predictive value of each field in a data record and allows to obtain more accurate similarity scores in the context of disclosed method. The non-linear similarity models can be either gradient boosting models or neural network models, including for example XGBoost, Random Forest or Neural Nets machine learning algorithms.

Once the different models are trained, an initial dataset of data records can be used as input to the proposed system, to perform the proposed clustering of data records. The proposed method of clustering is especially useful for improving the reconciliation process of transaction records comprising monetary values, but it is possible to use the proposed method for other applications.

An initial dataset of data records, exemplified by the table 150 of FIG. 1, is provided. If values are missing, values are estimated or predicted, using the classifier model 310 previously trained. Depending on the size and/or processing capacity of the servers/processing devices performing the method, the data records can be automatically classified in groups, based on values contained in predetermined fields of the records, so as to reduce the computational burden of the pairwise comparisons. In the example of FIG.1, the “process” field is used, but one or more fields can be used to group the data records.

For each group, comparison vectors are generated, by first generating non-repeated pairs in a group, and by comparing the values of the same fields for the two datas. Each comparison vector thus includes comparison result values indicative of the similarity of the values for a field of a pair of data records. Preferably, the comparison values are standardized, prior to being fed to the trained non-linear similarity models. The standardization operations must be the same as those used during the training process.

The comparison vectors for each group of data records (such as transaction records) are store in memory and fed or inputted to their corresponding trained non-linear similarity models. As an output, similarity scores are generated and stored in memory, each similarity score providing an indication of the degree of similarity between the two data records in the pair. As schematically illustrated in FIG. 5, the similarity scores outputted by the non-linear similarity model are comprised in an N×N matrix data structure (170b-170f), where “N” corresponds to the number of data records in the group. Each element or entry of the matrix, n_{i,j} is a similarity score indicative of the similarity of two records (i and j) of the group.

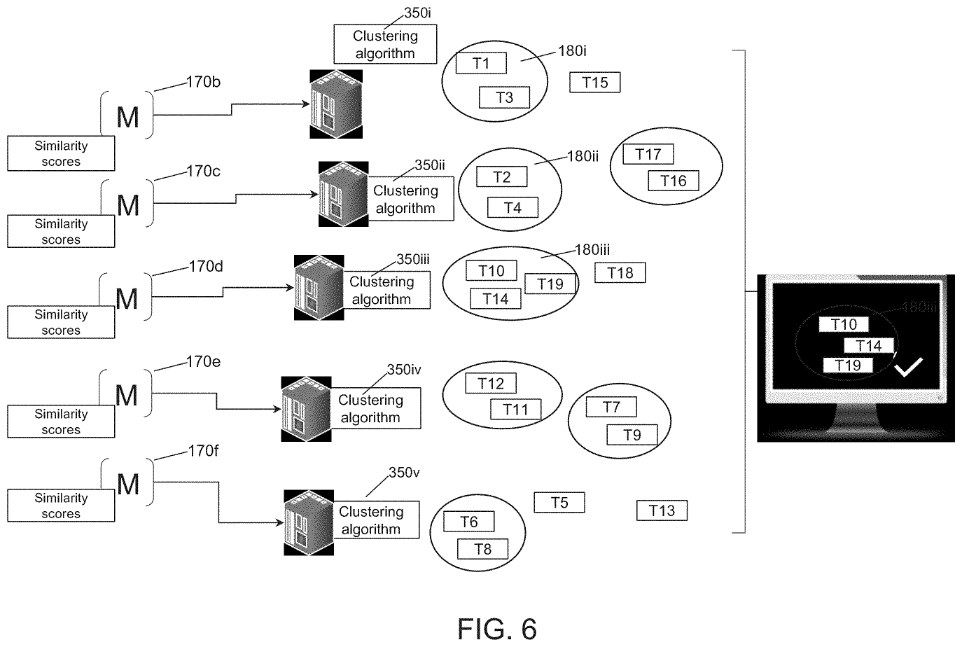

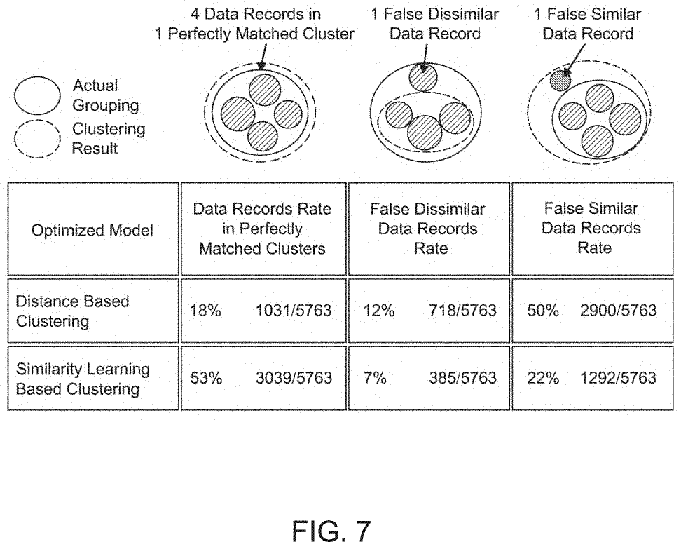

Referring now to FIG. 6, the similarity scores, typically structured as matrices (170b-170f), are inputted to clustering algorithms 350. As can be appreciated, instead of inputting distance matrices as is typical with clustering algorithms, similarity scores obtained from non-linear similarity models are used. As will be demonstrated from the results shown in FIG. 7, the number of matched clusters of data records is substantially increased compared to traditional distance based clustering.

Multiple instances of the clustering algorithm module 350i-350v (DBScan, for example) can be used, one for each group, such that the clustering can be run in parallel, for all groups. In alternate embodiments, it would be possible to use a single clustering module 350 to process the similarity scores from each group serially, depending on processing capacities. For each group, the corresponding matrix is fed to the corresponding clustering algorithm module 350, which are run in parallel and create therefrom clusters (180i-180iii) of data records, which are, in some implementations, more likely to be similar and reconciled with one another. As schematically illustrated in FIG. 6, clusters can include two or more data records, and there may be clusters with a single data record. The clustering algorithms 350i-350v can be of different types. In a prototype version of the proposed method and system, the DBSCAN algorithm has been found to provide successful results. When using DBSCAN, a cluster identification (ID) is attributed to each record (such as a transaction record), such that they can be grouped. The clustering process can be tuned by modifying intrinsic parameters of the algorithms, for example by adjusting parameters that modify the thresholds based on which a cluster ID is attributed. With DBSCAN algorithms, the “epsilon” parameter sets the minimal score according to which data records are to be clustered together (i.e. attributed the same cluster ID).

According to possible implementations, at this point, the data records that are members of a cluster can be determined as reconciled automatically, or the members of a cluster can be displayed on a display 190 in a graphical user interface, so that an end user can confirm whether the members are reconciled or not. If data records are determined as being reconciled, automatically or by an end user, they are removed from the dataset. In possible implementations, the method can include a step of prompting an end user to confirm the removal of the data records in a cluster, for example by displaying the clustered data records in a graphical user interface and by detecting an input from the end user, via a keyboard, a mouse or a microphone. In other possible embodiments, the data records can be removed automatically, without prompting a user for confirmation.

Reconciled (or matched) data records can be determined based on the values of the predetermined fields of the records. In possible implementations, at least one of the predetermined fields of each data record comprises a monetary value, as in the example of FIG. 1. In this case, an automated process can compute the sum of the monetary values of each data record in a cluster and remove the records if the sum or absolute value of the sum is below a predetermined threshold, such as when the threshold is proximate to zero.

The process is repeated for at least a portion of the clusters, and preferably for all clusters, the reconciled data records being removed after each iteration of the process. In possible implementations, once the initial dataset has been processed, additional datasets can be processed using the same modules (310-350). The unreconciled data records of the initial dataset (for example T15, T18, T5 and T13 in FIG. 6) can be added or reinjected to the next dataset. The method can thus be conducted, continuously and/or periodically, by repeating steps 520-570 (identified in FIG. 7) with additional datasets of data records (step 590) while keeping the remaining data records of previous datasets that have not been removed or reconciled (step 580), thereby improving the reconciliation rate of records (such as transactions) that are scattered between different transaction datasets. It is possible that a data record that is part of a first dataset on a given day, or week, is reconcilable with a data record of second dataset that has not yet been processed by the reconciliation application 200. The proposed method is particularly useful in that data records that were unreconciled in a first instance of the process can be clustered with other data records in following iterations of the process.

According to a possible implementation, for unreconciled records, a follow-up indicator can be created to improve their reconciliation in the next iterations of the process. If the data records of a cluster have not been reconciled or matched, then for each pair of transaction record of the cluster, a set of conditions can be applied to determine if they can be assigned the same follow-up indicator. The conditions can include for example whether values in the sender and receiver fields are the same, and the difference in days between the two data records, as examples only. The follow-up indicator can be added automatically by the system, and further help on improving the reconciliation rate.

According to a possible implementation, the non-linear similarity models can be continuously retrained, using the initial and additional datasets, to increase the accuracy and efficiency of the clustering process. Moreover, a monitoring and evaluation system can be used in combination of the automated clustering system. For example, as explained with reference to FIG. 5, the data records of a given group (G1 to G6) are feed to different non-linear similarity model. The monitoring and evaluation system can continuously or periodically monitor the performance of the different models, determine if new / different models should be used, and can also monitor the impact of model parameter updates. In addition, the monitoring and evaluation system can compare the performance of new non-linear similarity models with previous models and can evaluate the impact of rules/conditions updates on the reconciliation rate. The monitoring and evaluation system comprises a graphical user interface (GUI) on which the performance of the different models can be displayed, such as with graphs and tables.

Referring now to table 1 below shows experimental results of a comparison between different types of similarity functions used along the same clustering algorithm for grouping transaction records.

TABLE 1
Comparing performance results for different similarity functions
Overall Clustering Results of C + D Transactions
Optimal Clustering Results of Total (Credit + Debit) Transactions for Three Types of Models

| | Credit + Debit | Total | Total | Perfectly | Transactions | | False |
|---|---|---|---|---|---|---|---|
| Experiment | Testing | Produced | Original | Matched | in Perfect | False Similar | Dissimilar |
| Groups | Transactions | Clusters | Group_ID | Clusters | Clusters | Transactions | Transactions |
| Euclidean | 5760 | 3983 | 2359 | 604/2359 | 788/5760 | 1168/5760 | 2842/5760 |
| DBSCAN | | | | 25.60% | 13.68% | 20.28% | 49.34% |
| Overall | | | | | | | |
| Performance | | | | | | | |
| Cosine | 5760 | 4715 | 2359 | 834/2360 | 1030/5760 | 480/5760 | 2904/5760 |
| Similarity | | | | 35.35% | 17.88% | 8.33% | 50.42% |
| DBSCAN for | | | | | | | |
| Embedding | | | | | | | |
| Pretrained | 5760 | 2542 | 2359 | 1546/2359 | 2356/5760 | 650/5760 | 628/5760 |
| Random | | | | 65.64% | 56.53% | 10.90% | 11.28% |
| Forest (RF) | | | | | | | |
| Function + | | | | | | | |
| DBSCAN | | | | | | | |
| Overall | | | | | | | |
| Performance | | | | | | | |

As described herein, experimental results show that a pretrained Random Forest non-linear similarity model (fourth row) used with DBSCAN outperforms Euclidean (second row) and Cosine (third row) distance-based functions, used with the same clustering algorithm (DBSCAN) for creating clusters of similar transaction records. Indeed, with an initial testing dataset comprising 5760 transaction records known to be scattered into 2359 reconcilable groups, the trained-linear similarity function allowed for the creation of more perfectly matched clusters (1546), comprising more transaction records (3256), where the sum of values of the transaction records in these cluster equals 0. Furthermore, the trained non-linear similarity model allowed for the creation of 2542 clusters, a number of clusters much closer to the original number of clusters known to be contained in the testing dataset when compared to the other similarity functions. These results are also obtained with less false similar or false dissimilar data records within the clusters created by using a trained non-linear similarity model.

FIG. 7 shows more experimental results for different similarity functions inputted to the clustering algorithms. Similarity functions based on distance are typically fed to clustering algorithms in order to form clusters. When using a distance-based model, only 18% o 5467 data records are matched. The inventors of the proposed system and method show that inputting a learned similarity function to the clustering algorithm increases the true reconciliation rate from 18% to 53%, while reducing the rate of false dissimilar and false similar transaction rates.

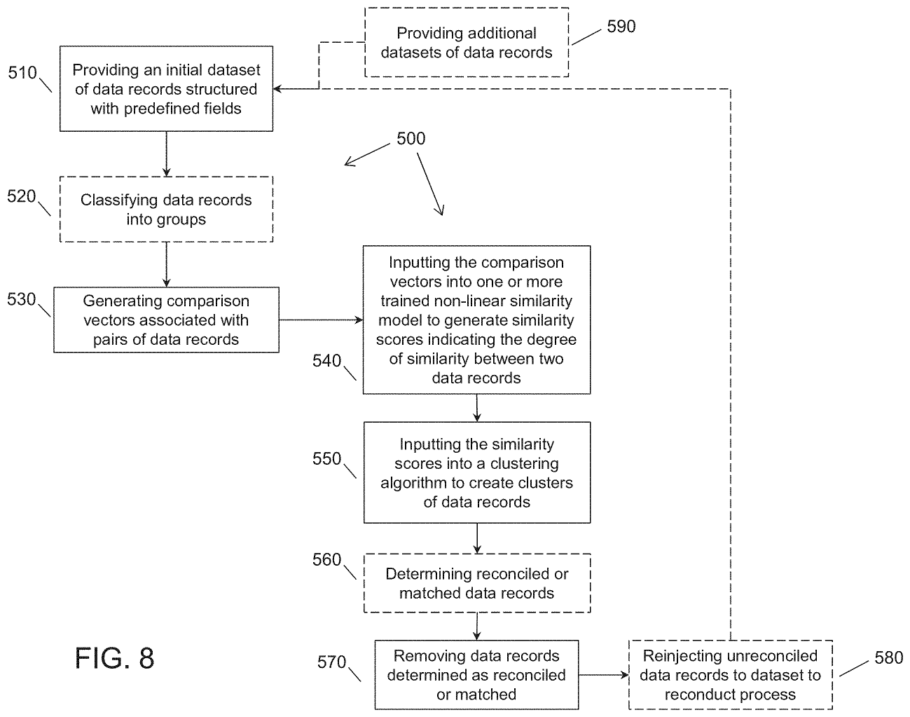

Referring now to FIG. 8, the different steps 510-590 of the clustering method 500 described previously, are represented as a flow chart, with optional steps being shown in broken line boxes. As can be appreciated, the proposed method and system allow forming clusters of data records using a clustering algorithm that is fed with similarity scores. In some implementations, the data records can include transaction records, such as monetary transaction records, and the similarity scores are estimated or predicted, using training transaction records which have been previously labelled as reconciled or unreconciled. The clusters formed with the proposed method allowed grouping transaction records that are more likely to be reconciled, while reducing the number of false similar or dissimilar transaction records. Consequently, the reconciliation rate of transaction records was increased, and the processing time and computational burden of the process has been reduced. The process allows reinjecting transaction records that were not reconciled into the following datasets that are processed, which further increases the overall reconciliation rate of transactions over time.

According to an aspect, an automated computer-implemented method for grouping transactions for improving the efficiency of a reconciliation process is provided. The method comprises a step of providing an initial dataset of transaction records, each transaction record being structured with predetermined fields. The method also comprises a step of generating, by a processor, comparison vectors associated with pairs of transaction records from the initial dataset, each vector being associated with a pair comprising a set of values. Each value is associated with one of the predetermined fields and represents a comparison result of the values in said field for the first and second transaction records of a pair. The method also comprises a step of inputting the comparison vectors into a trained non-linear similarity model, stored onto a storage medium, and a step of generating therefrom similarity scores. Each similarity score provides an indication of the degree of similarity between the two transaction records in the pair. The method also comprises a step of inputting, by the processor, the similarity scores into a clustering algorithm, and creating therefrom clusters of transaction records. The method also comprises a step of removing, by the processor, from the dataset, transactions in the created clusters that have been determined as reconciled transactions.

According to possible implementations, one or more of the predetermined fields of each transaction record comprises a monetary value, wherein a cluster is removed when the sum of the monetary values of the one or more field(s) of each transactions in the cluster is below a predetermined threshold. In possible implementations, the threshold can be proximate to zero.

According to possible implementations, each cluster can comprise two or more transactions that are likely to be reconciled.

According to possible implementations, the method can comprise a step of determining reconciled transactions in the created clusters, based on the values of the predetermined fields of the transaction records.

According to possible implementations, the method can comprise a step of automatically classifying the transaction records into a plurality of groups, based on values contained in at least some of the predetermined fields. The steps of generating the comparison vectors, inputting the vectors into the trained non-linear similarity model to generate similarity scores, and the step of inputting the similarity scores into clustering algorithm(s) can be performed for each group, where a distinct trained non-linear model is associated with each group, for reducing computational requirements when comparing pairs of transaction records.

According to possible implementations, the predetermined fields of a transaction record comprise at least one of: a sender identification, a receiver identification, a date and time of the transaction, a transit number, one or more types or characteristics of the transaction.

According to possible implementations, the classification of the transaction records in a group can be made by using a transaction type field or a transaction characteristic field of the transaction records.

According to possible implementations, the transaction records can pertain to different datasets. In this case, the method may comprise periodically repeating steps of the method with additional datasets of transaction records while keeping the remaining transaction records of previous datasets that have not been removed or reconciled, thereby improving a reconciliation rate of transactions that are scattered between different transaction datasets.

According to possible implementations, the method can comprise removing of reconciled transactions from the initial dataset and additional dataset(s), after each iteration of the steps described in paragraph [6]. According to possible implementations, entire clusters of reconciled transactions can be removed after each iteration.

According to possible implementations, the method can comprise a step of estimating values of transaction records having unpopulated or missing fields, prior to classifying the records into groups, the estimated values being obtained by using a classifier model trained on transaction records in which fields are all populated. In possible implementations, the classifier model is a decision tree type classifier model or a neural network model.

According to possible implementations, the values of the comparison vectors are generated using one or more comparison models, comprising as examples only: true/false comparison models for categorical or entity values, difference comparison models or distance models for numeral values.

According to possible implementations, the method comprises standardizing the values of the comparison vectors into numerical values, prior to inputting the comparison vectors into the trained non-linear similarity model.

According to possible implementations, the method includes training the non-linear similarity model. Training of the model comprises providing a training dataset of training transaction records, the training transaction records being structured with the same predetermined fields as those of the transaction records of the initial and additional datasets. The training also comprises generating training comparison vectors associated to pairs of training transaction records, each training comparison vector being associated with a pair comprising a set of values, each value being associated to one field and representing a comparison result of the values in said field for the first and second training transactions of a pair. A machine learning model is trained using the training comparison vectors, to generate a trained non-linear similarity model and determine a similarity between pairs of transaction records.

According to possible implementations, the training process comprises determining groups of training transaction records before generating comparison vectors, wherein groups are based on the values contained in at least some of the fields of the training transaction records, so as to label the transaction records of the training dataset into said groups and train a non-linear similarity model for each group.

In possible implementations, the training comparison vectors are attributed to labels, such as to a similar label and a dissimilar label, before training the machine learning model, the training of the machine learning model being therefore a supervised training.

According to possible implementations, the training comparison vectors have not been labelled, before training the machine learning model, the training of the machine learning model being therefore an unsupervised training.

According to possible implementations, the training process comprises a step of estimating values of training transaction records having unpopulated or missing fields, prior to classifying the records into groups, the estimated values being determined by using a classifier model trained on transaction records which fields are all populated.

According to possible implementations, the trained non-linear similarity models are either gradient boosting models or neural network models. The trained non-linear similarity models can comprise at least one of: a XGBoost machine learning algorithm, a Random Forest or a Neural Nets machine learning algorithm.

According to possible implementations, the similarity scores outputted by the non-linear similarity model are comprised in an N×N matrix which is inputted into the clustering algorithm, wherein N corresponds to the number of transactions in the group.

According to possible implementations, the clustering algorithm is a Density-Based Spatial Clustering of Applications with Noise (DBSCAN) algorithm.

According to possible implementations, the step of removing transactions comprises a step of prompting a user to confirm the removal of the transaction records in a cluster by displaying the clustered transaction records in a graphical user interface.

According to possible implementations, the step of removing transactions is made automatically, without prompting a user for confirmation.

According to possible implementations, the transaction records that have been removed are added to the training data set of the corresponding group, whereby the non-linear similarity model associated to the group is retrained with transaction records from the initial and additional datasets.

According to possible implementations, the method can comprise adjusting a parameter of the clustering algorithm, for each of the groups, where the parameter sets a threshold that determines whether a given transaction record is to be attributed to a given cluster. In possible implementation, the method comprises adjusting an epsilon parameter of the DBSCAN clustering algorithm, for each of the groups, the epsilon parameter setting the threshold determining whether or not a given transaction record is to be attributed to a given cluster.

According to another aspect, there is provided an automated and dynamic method for clustering records of data. The method comprises a) providing a dataset of records, each record being structured with predefined features. The method also comprises b) generating comparison vectors associated with pairs of records, each vector associated with a pair comprising a set of values, each value being associated with one of the predefined features and representing a comparison result of the values of said predefined feature for the first and second records of the pair. The method comprises c) inputting the comparison vectors into a trained non-linear similarity model, and generating therefrom similarity scores, each similarity score providing an indication of the degree of similarity between two records of a pair in the group. The method also comprises d) inputting the similarity scores into a clustering algorithm and creating clusters of records therefrom. The method also comprises e) outputting the clusters created to a graphical user interface or to a processing device for further treatment.

In possible implementation, the method defined in paragraph [30] comprises removing data records from clusters; and periodically repeating steps b) to e) with additional datasets of records while keeping the remaining records of previous datasets that have not been removed, thereby improving the clustering of data records that are spread across different transaction datasets.

According to another aspect, an automated and dynamic method implemented by a computer for reconciling transactions pertaining to different transaction datasets is provided. The method comprises a) providing an initial dataset of transaction records, each transaction record being structured with predetermined fields, at least one of the fields comprising a monetary value; b) automatically classifying the records into groups, based on values contained in at least some of the predetermined fields; c) for each group: generating comparison vectors associated with pairs of transaction records from the initial data set, each vector associated with a pair comprising a set of values, each value being associated with one field and representing a comparison result of the values in said field for the first and second transaction records of a pair; inputting the comparison vectors into a trained non-linear similarity model for the group, and generating therefrom a matrix of similarity scores, each similarity score providing an indication of the degree of similarity between the two transaction records in the pair of the group; inputting the matrix of similarity scores for the group into a clustering algorithm, and creating therefrom clusters of transaction records; and determining reconciled transactions in a given one of the clusters based on a sum of the monetary values of the transaction records therein, and removing reconciled transaction records from the initial dataset; and d) periodically repeating steps b) to d) with additional datasets of transaction records while keeping the remaining transaction records of previous datasets that have not been reconciled, thereby improving a reconciliation rate of transactions that are scattered between different transaction datasets.

According to another aspect, an automated and dynamic system for reconciling transactions pertaining to different transaction datasets is provided. The system comprises: one or more databases for storing an initial dataset of transaction records, each transaction record being structured with predetermined fields, at least one of the fields comprising a monetary value. The system also comprises a grouping module for automatically classifying the records into groups, based on values contained in at least some of the predetermined fields; a pair generator and a comparison algorithm tool box for generating, comparison vectors associated with pairs of transaction records from the initial data set, each vector associated with a pair comprising a set of values, each value being associated with one field and representing a comparison result of the values in said field for the first and second transaction records of a pair; trained non-linear similarity models receiving as an input the comparison vectors into a group, and generating therefrom a matrix of similarity scores, each similarity score providing an indication of the degree of similarity between the two transaction records in the pair of the group; a clustering algorithm for receiving as an input the matrix of similarity scores, and creating therefrom clusters of transaction records; and a graphical user interface for receiving as input reconciled transactions in a given one of the clusters based on a sum of the monetary values of the transaction records therein and means for removing reconciled transaction records from the initial dataset.

According to another aspect, there is provided a non-transitory storage medium comprising processor-executable instructions to perform any variant of the methods described above.

Of course, numerous modifications could be made to the embodiments described above without departing from the scope of the present disclosure.

1. An automated computer-implemented method for grouping data records for improving the efficiency of a clustering process, the method comprising:
a) accessing, from one or more storage systems, an initial dataset of data records, each data record being structured with predetermined fields;
b) generating, by a processor, comparison vectors associated with pairs of data records from the initial dataset, each vector associated with a pair comprising a set of values, each value being associated with one of the predetermined fields and representing a comparison result of the values in said field for the first and second data records of a pair;
c) inputting the comparison vectors into a trained non-linear similarity model, stored onto a storage medium, and generating therefrom similarity scores, each similarity score providing an indication of the degree of similarity between the two data records in the pair;
d) inputting, by the processor, the similarity scores into a clustering algorithm, and creating therefrom clusters of data records;
e) removing, by the processor, from the dataset, data records in the created clusters that have been determined as reconciled.

2. The computer-implemented method according to claim 1, wherein the data records pertain to different datasets, and wherein the method comprises periodically repeating steps b) to e) with additional datasets of data records while keeping the remaining data records of previous datasets that have not been removed or reconciled, thereby improving a reconciliation rate of the data records that are scattered between the different datasets.

3. The computer-implemented method according to claim 2, comprising removing, after each iteration of step e), reconciled data records from the initial dataset and from the additional dataset(s).

4. The computer-implemented method according to claim 3, wherein entire clusters of reconciled data records are removed after each iteration of step e).

5. The computer-implemented method according to claim 2, comprising automatically classifying the data records into a plurality of groups, based on values contained in at least some of the predetermined fields, and wherein steps b) to e) are performed for each group, a distinct trained non-linear model being associated with each group, for reducing computational requirements when comparing pairs of data records.

6. The computer-implemented method according to claim 5, comprising a step of adjusting a parameter of the clustering algorithm, for each of the groups, said parameter setting a threshold that determines whether or not a given data record is to be attributed to a given cluster.

7. The computer-implemented method according to claim 6, wherein the clustering algorithm is a Density-Based Spatial Clustering of Applications with Noise (DBSCAN) algorithm.

8. The computer-implemented method according to claim 7, wherein the parameter is an epsilon parameter, the method comprising a step of adjusting the epsilon parameter of the DBSCAN clustering algorithm, for each of the groups.

9. The computer-implemented method according to claim 5, wherein classifying the data records in a group is made by using a transaction type field or a transaction characteristic field of the data records.

10. The computer-implemented method according to claim 5, comprising a step of estimating values of data records having unpopulated or missing fields, prior to classifying the records into groups, the estimated values being obtained by using a classifier model trained on data records in which fields are all populated.

11. The computer-implemented method according to claim 10, wherein the classifier model is a decision tree type classifier model or a neural network model.

12. The computer-implemented method according to claim 11, wherein the values of the comparison vectors are generated using one or more comparison models, comprising true/false comparison models for categorical or entity values and difference comparison models or distance models for numeral values.

13. The computer-implemented method according to claim 12, comprising a step of standardizing the values of the comparison vectors into numerical values, prior to inputting the comparison vectors into the trained non-linear similarity model.

14. The computer-implemented method according to claim 13, wherein the trained non-linear similarity models comprise at least one of: a XGBoost machine learning algorithm, a Random Forest or a Neural Nets machine learning algorithm.

15. The computer-implemented method according to claim 14, wherein the similarity scores outputted by the non-linear similarity model are comprised in an NxN matrix which is inputted into the clustering algorithm, wherein N corresponds to the number of data records in the group.

16. The computer-implemented method according to claim 1, wherein at least one of the predetermined fields of each data record comprises a monetary value, and wherein the sum of the monetary values of the at least one field of each data record in a cluster that is removed is below a predetermined threshold.

17. The computer-implemented method according to claim 1, wherein the predetermined fields of a data record comprise at least one of: a sender identification, a receiver identification, a date and time, a transit number, one or more types or characteristics of a transaction.

18. The computer-implemented method according to claim 1, wherein training of the non-linear similarity model comprises the following steps:
i) providing a training dataset of training data records, the training data records being structured with the same predetermined fields as those of the data records of the initial and additional datasets;
ii) generating training comparison vectors associated to pairs of training data records, each training comparison vector being associated with a pair comprising a set of values, each value being associated to one field and representing a comparison result of the values in said field for the first and second training data records of a pair; and
iii) training a non-linear similarity model by inputting therein the training comparison vectors, to determine or predict a similarity between pairs of data records.

19. The computer-implemented method according to claim 19, comprising determining groups of training data records before generating comparison vectors, wherein groups are based on the values contained in at least some of the fields of the training data records, so as to classify the data records of the training dataset into said groups and train a non-linear similarity model for each group.

20. The computer-implemented method according to claim 20, wherein the trained non-linear similarity models are either gradient boosting models or neural network models.

21. The computer-implemented method according to claim 20, wherein the data records that have been removed are added to the training dataset of the corresponding group, whereby the non-linear similarity model associated to the group is retrained with data records from the initial and additional datasets.

22. An automated and dynamic system for clustering data records pertaining to different datasets, the system comprising:
one or more storage systems for storing an initial dataset of data records, each data record being structured with predetermined fields;
a pair generator and a comparison algorithm toolbox for generating comparison vectors associated with pairs of data records from the initial dataset, each vector associated with a pair comprising a set of values, each value being associated with one field and representing a comparison result of the values in said field for the first and second data records of a pair;
at least one trained non-linear similarity model receiving as an input the comparison vectors, and generating therefrom a matrix of similarity scores, each similarity score providing an indication of the degree of similarity between the two data records in the pair of the group;
a clustering algorithm for receiving as an input the matrix of similarity scores, and creating therefrom clusters of data records; and
a graphical user interface for receiving as input reconciled data records in a given one of the clusters and for removing reconciled data records from the initial dataset.

23. The automated and dynamic system according to claim 22, further comprising:
a grouping module for automatically classifying the data records into groups, based on values contained in at least some of the predetermined fields;
wherein the at least one trained non-linear similarity model comprises a plurality trained non-linear similarity models associated with each group, for receiving as an input the comparison vectors of a group.

24. A non-transitory storage medium comprising processor-executable instructions for causing a processor to:
e) generate comparison vectors associated with pairs of data records from an initial dataset of data records, each data record being structured with predetermined fields, each vector associated with a pair comprising a set of values, each value being associated with one of the predetermined fields and representing a comparison result of the values in said field for the first and second data records of a pair;
f) input the comparison vectors into a trained non-linear similarity model and generate therefrom similarity scores, each similarity score providing an indication of the degree of similarity between the two data records in the pair;
g) input the similarity scores into a clustering algorithm, and create therefrom clusters of data records;
h) remove from the dataset, data records in the created clusters that have been determined as reconciled.
